(19) United States
(12) Patent Application Publication
(10) Pub. No.: US 2020/0294270 A1
(43) Pub. Date: Sep. 17, 2020

(54) PATCH EXTENSION METHOD, ENCODER AND DECODER

(71) Applicant: Industrial Technology Research Institute, Hsinchu (TW)

(72) Inventors: Sheng-Po Wang, Taoyuan City (TW); Erh-Chung Ke, Hsinchu City (TW); Yi-Ting Tsai, Taipei City (TW); Chun-Lung Lin, Taipei City (TW); Ching-Chieh Lin, Taipei City (TW)

(73) Assignee: Industrial Technology Research Institute, Hsinchu (TW)

(21) Appl. No.: 16/699,114

(22) Filed: Nov. 29, 2019

Related U.S. Application Data
(60) Provisional application No. 62/818,761, filed on Mar. 15, 2019.
(60) Provisional application No. 62/849,976, filed on May 20, 2019.

(51) Int. Cl. G06T 9/00; G06T 11/00

(52) U.S. Cl. CPC G06T 9/00; G06T 2210/56; G06T 11/001

(57) ABSTRACT

A patch extension method, an encoder and a decoder are provided. The method includes: obtaining a point cloud including a plurality of points; obtaining a first patch according to the point cloud, wherein the first patch is a subset of the point cloud; for at least one sampling point in the first patch, obtaining at least one neighboring point in the point cloud less than a first threshold away from the sampling point; and adding the neighboring point to the first patch.

### CROSS-REFERENCE TO RELATED APPLICATION

This application claims the priority benefits of U.S. provisional application Ser. No. 62/818,761, filed on Mar. 15, 2019 and U.S. provisional application Ser. No. 62/849,976, filed on May 20, 2019. The entirety of each of the above-mentioned patent applications is hereby incorporated by reference herein and made a part of this specification.

### TECHNICAL FIELD

The disclosure relates to a patch extension method, an encoder and a decoder.

### BACKGROUND

A point cloud is a plurality of points in 3D space, and each point among the points includes location information, color information or other information. In the conventional Point Cloud Compression (PCC) technology, an encoder divides data of the point cloud into multiple patches, and each patch is a subset of the point cloud. Then, the encoder may generate compressed data based on these patches. A decoder may obtain the patches based on the compressed data, and reconstruct (or restore) the data of the point cloud before compression based on the obtained patches.

However, because the patches have been compressed by the encoder, when the decoder obtains the patches from the compressed data and reconstructs (or restores) the data of the point cloud before compression based on the patches, a crack may occur due to distortion at intersections of the patches of the point cloud. This crack will reduce data quality of the point cloud (i.e., a point cloud image) decoded by the decoder.

### SUMMARY

Accordingly, the disclosure provides a patch extension method, an encoder and a decoder that can effectively solve the problem of the crack occurred due to distortion at the intersections of the patches, so as to improve data quality of the point cloud decoded by the decoder.

The disclosure proposes a patch extension method, which includes: obtaining a point cloud including a plurality of points; obtaining a first patch according to the point cloud, wherein the first patch is a subset of the point cloud; for at least one sampling point in the first patch, obtaining at least one neighboring point in the point cloud less than a first threshold away from the sampling point; and adding the neighboring point to the first patch.

The disclosure proposes an encoder, which includes: a patch generation module, a patch expanding module, a compression module and an output module. The patch generation module is configured to obtain a point cloud including a plurality of points and obtain a first patch according to the point cloud. The first patch is a subset of the point cloud. The patch expanding module is configured to, for at least one sampling point in the first patch, obtain at least one neighboring point in the point cloud less than a first threshold away from the sampling point, and add the neighboring point to the first patch. The compression module is configured to compress the first patch added with the neighboring point to obtain compressed data. The output module is configured to output the compressed data.

The disclosure proposes a decoder, which includes: a decompression module, a patch expanding module, a point cloud reconstruction module. The decompression module is configured to decompress at least one compressed data corresponding to a point cloud including a plurality of points to obtain at least one decompressed data. The decompressed data includes a first patch and the first patch is a subset of the point cloud. The patch expanding module is configured to, for at least one sampling point in the first patch, obtain at least one neighboring point in the point cloud less than a first threshold away from the sampling point, and add the neighboring point to the first patch. The point cloud reconstruction module is configured to reconstruct the point cloud according to the first patch added with the neighboring point to obtain the reconstructed point cloud.

Based on the above, the patch extension method, the encoder and the decoder of the disclosure can effectively solve the problem of the crack occurred due to distortion at the intersections of the patches, so as to improve data quality of the point cloud decoded by the decoder.

### BRIEF DESCRIPTION OF THE DRAWINGS

FIG. 1A is a schematic diagram illustrating an encoder according to an embodiment of the disclosure.

FIG. 1B is a schematic diagram illustrating operations of the encoder according to an embodiment of the disclosure.

FIG. 2 is a flowchart illustrating a method for finding a neighboring point according to an embodiment of the disclosure.

FIG. 3A and FIG. 3B illustrate schematic diagrams for adding the neighboring point to the patch according to an embodiment of the disclosure.

FIG. 4A is a schematic diagram illustrating a decoder according to an embodiment of the disclosure.

FIG. 4B is a schematic diagram illustrating operations of the decoder according to an embodiment of the disclosure.

FIG. 5 is a schematic diagram illustrating the effect of a patch extension method according to an embodiment of the disclosure.

FIG. 6 is a flowchart illustrating a patch extension method according to an embodiment of the disclosure.

### DETAILED DESCRIPTION

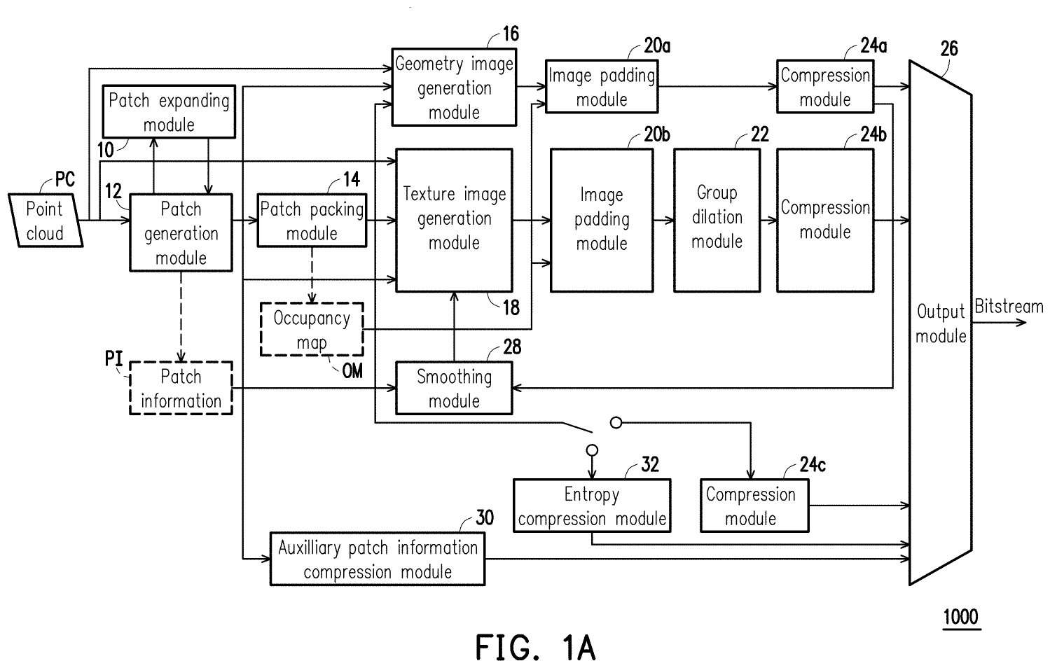

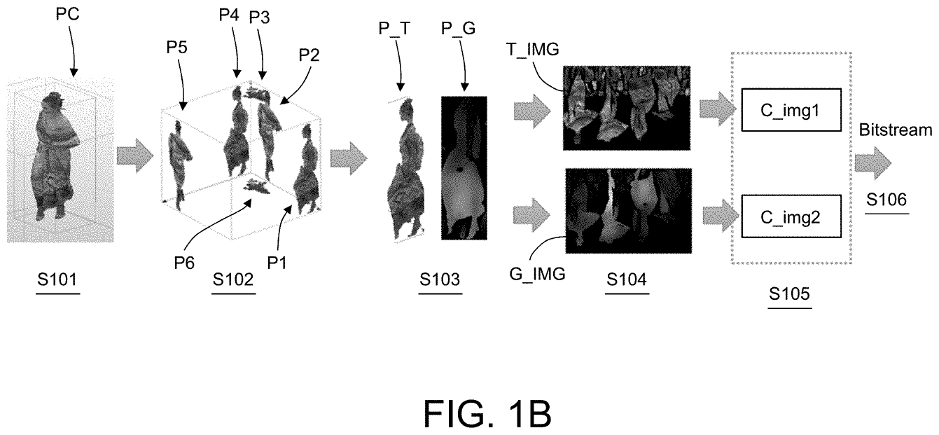

FIG. 1A is a schematic diagram illustrating an encoder according to an embodiment of the disclosure. FIG. 1B is a schematic diagram illustrating operations of the encoder according to an embodiment of the disclosure.

Referring to FIG. 1A, in this embodiment, an encoder 1000 includes a patch expanding module 10, a patch generation module 12, a patch packing module 14, a geometry image generation module 16, a texture image generation module 18, image padding modules 20a and 20b, a group dilation module 22, compression modules 24a to 24c, an output module 26, a smoothing module 28, an auxiliary patch information compression module 30 and an entropy compression module 32.

It should be noted that the encoder 1000 in FIG. 1A may be implemented by an electronic device. For instance, the electronic device may include a processor and a storage device. The electronic device may be a smart phone, a tablet computer a notebook computer or a personal computer.

The processor may be a central processing unit (CPU) or other programmable devices for general purpose or special purpose such as a microprocessor and a digital signal processor (DSP), a programmable controller, an application specific integrated circuit (ASIC) or other similar elements or a combination of above-mentioned elements.

The storage device may be a random access memory (RAM), a read-only memory (ROM), a flash memory, a hard Disk drive (HDD), a hard disk drive (HDD) as a solid state drive (SSD) or other similar devices in any stationary or movable form, or a combination of the above-mentioned devices.

In this exemplary embodiment, the storage device of the electronic device is stored with a plurality of program code segments. After being installed, the code segments may be executed by the processor of the electronic device. For example, the storage device of the electronic device includes each of the modules in FIG. 1A. Various operations of the encoder 1000 may be executed by those modules, where each of the modules is composed of one or more of the program code segments. However, the disclosure is not limited in this regard. Each of the operations may also be implemented in other hardware manners.

Referring to FIG. 1A and FIG. 1B together, first, the patch generation module 12 may obtain a point cloud PC including a plurality of points, and obtain a patch (hereinafter, referred to as a first patch) according to the point cloud PC. In particular, the first patch is a subset of the point cloud PC. In other words, the first patch includes a part of the points in the point cloud PC.

Take FIG. 1B for example, in step S101 of FIG. 1B, the patch generation module 12 obtains the point cloud PC. In step S102, the patch generation module 12 projects the plurality of points of the point cloud PC onto six 2D planes of a cubic. At least one patch may be obtained according to the points clustered on each 2D plane among the 2D planes. Taking step S102 in the schematic diagram of FIG. 1B as an example, it is assumed that the patch generation module 12 generates patches P1 to P6. For descriptive convenience, the following takes the patch P1 (i.e., the first patch described above) as an example for description. A similar method can be applied to other patches. It is assumed that the patch P1 has a plurality of points (a.k.a. first points) clustered together on a projected plane (a.k.a. a first 2D plane). Here, it is further assumed that the patch P1 is a 3D patch and the patch P1 include multiple points. Each of the points is configured to record location, color and other information in 3D space.

After obtaining the patch P1, in step S103, the patch generation module 12 generates a 2D patch corresponding to the patch P1 according to the 3D patch P1. Here, the 2D patch of the patch P1 includes a geometry image P_G and a texture images P_T. The geometry image P_G and the texture image P_T may be 2D images, respectively. The geometric image P_G is used to represent the location information (e.g., coordinates in 3D space) of the first points and the texture image P_T is used to represent the color information of the first points. Specifically, in step S103, for at least one sampling point in the patch P1, the patch expanding module 10 obtains at least one neighboring point in the point cloud PC less than a threshold (a.k.a. a first threshold) away from the sampling point, and adds the neighboring point to the patch P1. For example, the patch expanding module 10 adds a location of the neighboring point to the geometry image P_G of the patch P1 and adds a color of the neighboring point to the texture image P_T.

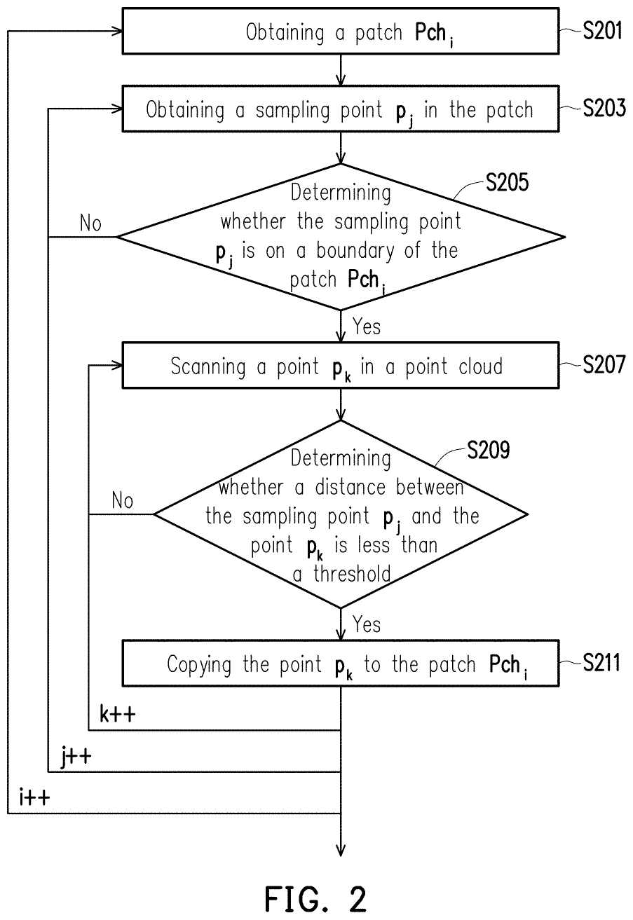

FIG. 2 is a flowchart illustrating a method for finding a neighboring point according to an embodiment of the disclosure. FIG. 2 is used to explain in detail how to find the neighboring point of the sampling point in the point cloud.

Referring to FIG. 2, in step S201, the patch expanding module 10 obtains a patch Pchᵢ in a point cloud where i is 1 to n, which are used to represent the first patch to the n-th patch. The patch expanding module 10 obtains a sampling point pⱼ in the patch in step S203, and determines whether the sampling point pⱼ is located on a boundary of the patch Pchᵢ in step S205. If the sampling point pⱼ is not located on the boundary of the patch Pchᵢ, step S203 is performed again to obtain another point in the patch Pchᵢ as the sampling point. If the sampling point pⱼ is located on the boundary of the patch Pchᵢ, the patch expanding module 10 scans a point pₖ in the point cloud in step S207, and determines whether a distance between the sampling point pⱼ and the point pₖ is less than a threshold (i.e., the first threshold) in step S209. If the distance between the sampling point pⱼ and the point pₖ is not less than the threshold, the patch expanding module 10 performs step S207 again to scan another point in the point cloud. If the distance between the sampling point pⱼ and the point pₖ is less than the threshold, the patch expanding module 10 copies the point pₖ to the patch Pchᵢ in step S211.

It should be noted that, in another embodiment, step S205 may be omitted. In other words, the patch expanding module 10 may also find the corresponding neighboring point in the point cloud for each point in the patch Pchᵢ and add the neighboring point to Pchᵢ.

In an embodiment, the patch expanding module 10 activates the process of FIG. 2 to execute the operation of obtaining the neighboring point in the point cloud less than the first threshold away from the sampling point only when a number of points in the patch Pchᵢ is greater than a threshold (a.k.a. a second threshold). In other words, when one particular patch is too small, the patch expanding module 10 does not find the neighboring point in the point cloud for the sampling point in that particular patch.

In an embodiment, when a plurality of matching neighboring points (i.e., with their distances less than the first threshold) are found for one particular sampling point, the patch expanding module 10 simply adds a number (a.k.a. a first number) of the neighboring points to the first patch, and the first number is less than a threshold (a.k.a. a third threshold). In other words, for one particular sampling point in the patch, only a certain number of the neighboring points are added to that particular patch so as to avoid adding too many neighboring points. The disclosure is not intended to limit how to select the neighboring point to be added to the patch from the found neighboring points.

It should be noted that, the neighboring point added to the patch usually belongs to another patch (a.k.a. a second patch) of the same point cloud. In other words, the second patch is another subset of the point cloud. By adding the point from a different patch to one patch, the problem of the crack occurred due to distortion at the intersections of the patches when the decoder is decoding may be solved.

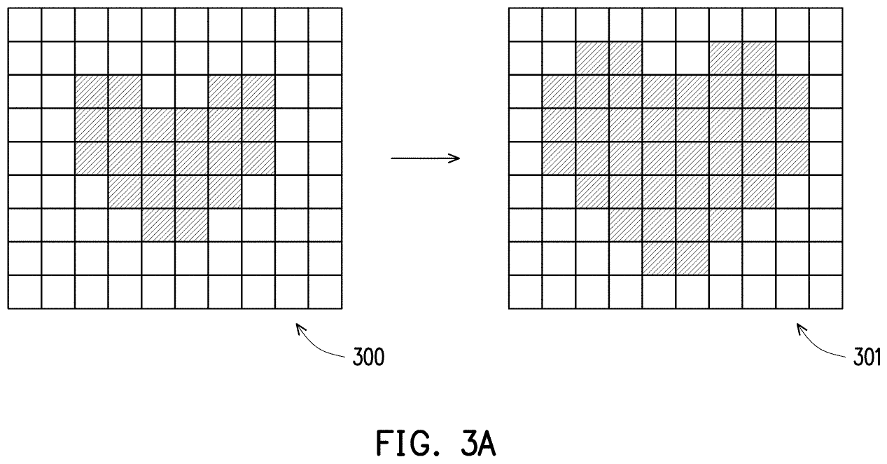

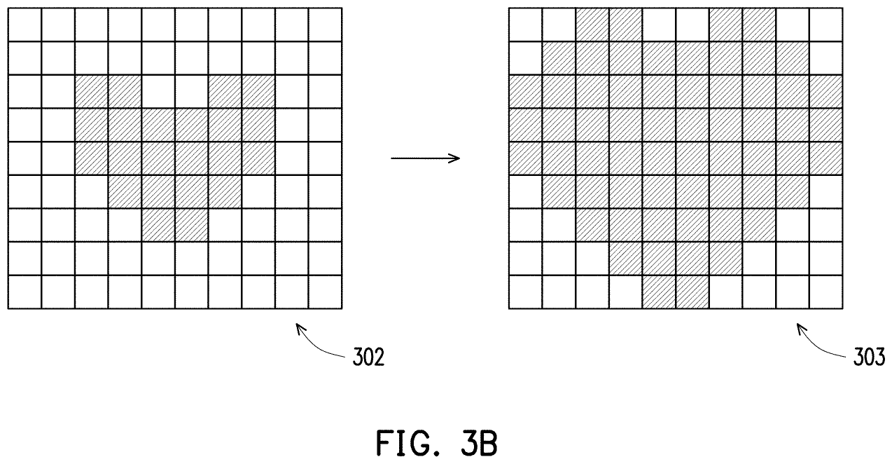

FIG. 3A and FIG. 3B illustrate schematic diagrams for adding the neighboring point to the patch according to an embodiment of the disclosure.

Referring to FIG. 3A, it is assumed that an image 300 is configured to represent a patch currently wanting to be added with the neighboring point. It is also assumed that the first threshold is 1. The patch expanding module 10 scans the points in the point cloud to find the neighboring point less than the first threshold away from each point (or only the point of each boundary) in the image 300, and adds the neighboring points to the patch to obtain a patch as shown by an image 301. Similarly, referring to FIG. 3B, it is assumed that an image 302 is configured to represent the patch currently wanting to be added with the neighboring point. It is also assumed that the first threshold is 2. The patch expanding module 10 scans the points in the point cloud to find the neighboring point less than the first threshold away from each point (or only the point of each boundary) in the image 300, and adds the neighboring points to the patch to obtain a patch as shown by an image 303.

Referring to FIG. 1A and FIG. 1B again, it should be noted that the patch P1 is first converted into the 2D patch including the geometry image P_G and the texture image P_T before the location and the color of the found neighboring point are respectively added to the geometry image P_G and the texture image P_T in the example above. However, the disclosure is not limited in this regard. In other embodiments, the neighboring point of each sampling point in the patch P1 may be found first, and after the neighboring points are added to the patch P1, the patch P1 added with the neighboring points is then converted to the 2D patch including the geometry image and the texture image. The geometry image and the texture image of that 2D patch will also include the location and the color of the neighboring point.

Subsequently, in step S104, the patch packing module 14 integrates the geometry image P_G added with the location of the neighboring point and another geometry image of another patch that also belongs to the first 2D plane as the patch P1 does. The geometry image generation module 16 generates an integrated geometry image G_IMG integrated from the geometry image P_G added with the location of the neighboring point and said another geometry image of said another patch belonging to the first 2D plane according to the point cloud PC, an output of the patch generation module 12 and an output of the patch packing module 14. In other words, this step is to integrate multiple geometry images into one single image.

Further, in step S104, the patch packing module 14 also integrates the texture image P_T added with the color of the neighboring point and another texture image of said another patch belonging to the first 2D plane. The, the texture image generation module 18 generates an integrated texture image T_IMG integrated from the texture image P_T added with the color of the neighboring point and said another texture image of said another patch belonging to the first 2D plane according to the point cloud PC, the output of the patch generation module 12 and the output of the patch packing module 14. In other words, this step is to integrate multiple texture images into one single image.

After the integrated geometry image G_IMG and the integrated texture image T_IMG are obtained, a pre-processing may be performed on each of the two images before compression. Taking the encoder 1000 of FIG. 1A as an example, the image padding module 20a may perform padding on empty spaces between the geometry images of the patches inside the integrated geometry image G_IMG to generate a piecewise smooth image suitable for image compression. Similarly, the image padding module 20b may perform padding on empty spaces between the texture images of the patches inside the integrated texture image T_IMG to generate a piecewise smooth image suitable for image compression. Then, the group dilation module 22 may perform an expansion of morphology on the integrated texture image T_IMG.

After the pre-processing is performed on the integrated geometry image G_IMG and the integrated texture image T_IMG, in step S105 of FIG. 1B, the compression module 24a compresses the integrated geometry image G_IMG to obtain compressed data C_img2 (a.k.a. first compressed data). The compression module 24b compresses the integrated texture image T_IMG to obtain compressed data C_img1 (a.k.a. second compressed data). Then, in step S106, the output module 26 may output the compressed data C_img1 and the compressed data C_img2 in form of bitstream.

In addition, the patch packing module may also generate an occupancy map OM. The occupancy map OM includes at least one occupied block and at least one empty block. Here, the occupied block is used to represent a block having data in a 2D map (i.e., the 2D image) corresponding to the patch, and the empty block is used to represent a block not having data in the 2D map. It should be noted that, the 2D map includes a plurality of pixels, and the 2D map may be divided into a plurality of blocks by a block size of n*n pixels in the 2D map, wherein n is a positive integer.

The geometry image generation module 16 and the texture image generation module 18 may refer to the occupancy map OM to generate the integrated geometry image and the integrated texture image separately. The image adding modules 20a and 20b may also perform functions by referring to the occupancy map OM. In addition, when the occupied map OM is to be compressed, it is possible to select the compression module 24c with loss compression or the entropy compression module 32 with lossless compression to obtain the compressed occupancy map OM and output the compressed occupancy map OM by the output module 26 in form of bitstream.

Particularly, in an embodiment, during the process of FIG. 2, when the neighboring point is added to the patch and a number of the occupied blocks corresponding to that patch is increased, the patch expanding module 10 does not add the neighboring point to the patch.

In the encoder 1000 of FIG. 1A, the patch generation module 12 may generate patch information PI. The patch information PI may record how many patches the point cloud PC has in total, which 2D plane each patch is on, or other information related to the point cloud or the patch. The smoothing module 28 may perform a smoothing operation according to the patch information PI and an output of the compression module 24a to generate a smooth geometry image, and input this smooth image to the texture image generation module 18.

The auxiliary patch information compression module 30 is mainly used to compress auxiliary (or additional) information related to the patch, and outputs the compressed auxiliary information through the output module 26 in form of bitstream.

It should be noted that, the patch expanding module 10 in FIG. 1A is coupled to the patch generation module 12. However, in other embodiments, a plurality of the patch expanding modules 10 may also be disposed behind the geometry image generation module 16 and the texture image generation module 18 to achieve similar effects.

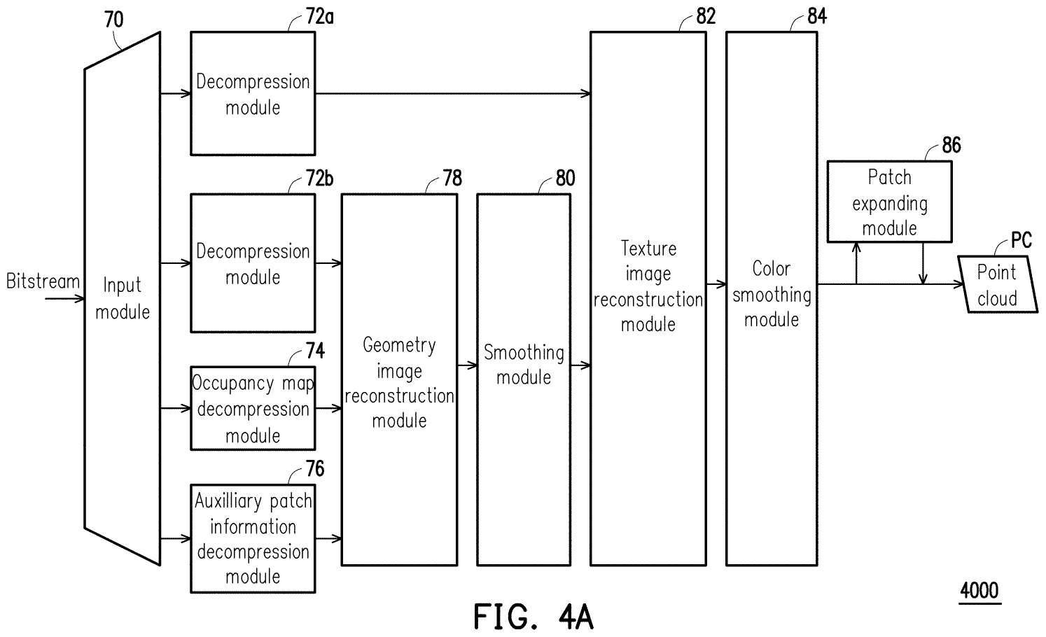

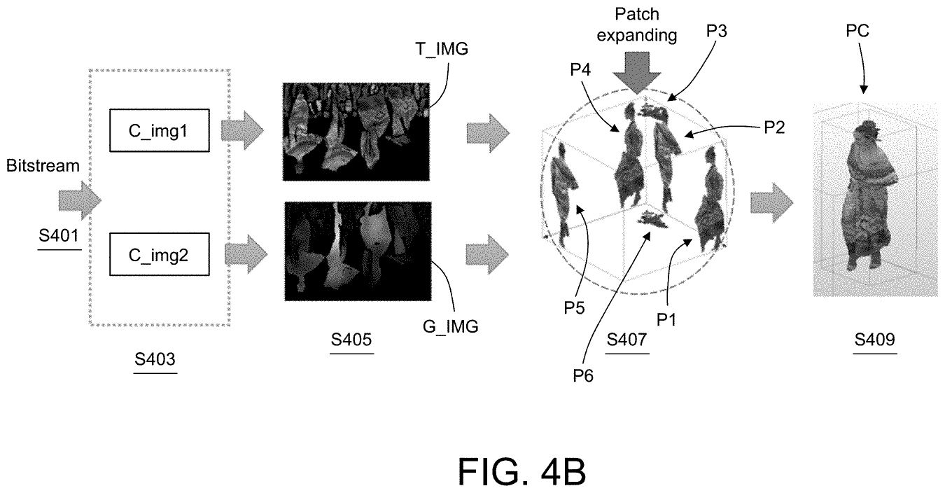

FIG. 4A is a schematic diagram illustrating a decoder according to an embodiment of the disclosure. FIG. 4B is a schematic diagram illustrating operations of the decoder according to an embodiment of the disclosure.

Referring to FIG. 4A, a decoder 4000 includes an input module 70, decompression modules 72a and 72b, an occupancy map decompression module 74, an auxiliary patch information decompression module 76, a geometry image reconstruction module 78, a smoothing module 80, a texture image reconstruction module 82, a color smoothing module 84 and a patch expanding module 86. The decoder 4000 may be implemented by an electronic device, for example. For instance, the electronic device may include a processor and a storage device. The electronic device may be a smart phone, a tablet computer a notebook computer or a personal computer.

In this exemplary embodiment, the storage device of the electronic device is stored with a plurality of program code segments. After being installed, the code segments may be executed by the processor of the electronic device. For example, the storage device of the electronic device includes each of the modules in FIG. 4A. Various operations of the decoder 4000 may be executed by those modules, where each of the modules is composed of one or more of the program code segments. However, the disclosure is not limited in this regard. Each of the operations may also be implemented in other hardware manners.

Referring to FIG. 4A and FIG. 4B together, in step S401, the input module 70 obtains a bitstream. The bitstream includes at least one compressed data corresponding to a point cloud including a plurality of points. The compressed data may include the compressed data C_img1 and the compressed data C_img2. Here, the decompressed data includes each patch and each patch is a subset of the point cloud. Then, in step S403, the decompression modules 72a and 72b, the occupancy map decompression module 74 and the auxiliary patch information decompression module 76 decompress the bitstream. More specifically, the decompression module 72a obtains the compressed data C_img1 from the bitstream and decodes the compressed data C_img1 to obtain the integrated texture image T_IMG in step S405. Similarly, the decompression module 72b obtains the compressed data C_img2 from the bitstream and decodes the compressed data C_img2 to obtain the integrated geometry image G_IMG in step S405. In addition, the occupancy map decompression module 74 obtains the compressed occupancy map from the bitstream and decodes the compressed occupancy map to obtain the decompressed occupancy map. The auxiliary patch information decompression module 76 obtains the compressed auxiliary patch information from the bitstream and decodes the compressed auxiliary patch information to obtain the decompressed auxiliary patch information.

Then, the geometry image reconstruction module 78 obtains the geometry image for each patch in the integrated geometry image G_IMG according to the integrated geometry image G_IMG output by the decompression module 72b, the occupancy map output by the occupancy map decompression module 74 and the auxiliary patch information output by the auxiliary patch information decompression module 76. The smoothing module 80 then performs a smoothing operation on the geometry image for each patch. In addition, the texture image reconstruction module 82 obtains the texture image for each patch according to the integrated texture image T_IMG output by the decompression module 72a and an image output by the smoothing module 80 after the smoothing operation. The color smoothing module 84 then performs a smoothing operation on the texture image for each patch. After the foregoing process, a plurality of patches P1 to P6 as shown in step S407 of FIG. 4B may be obtained. Each patch has the texture image and the geometry image. The geometry image is used to represent location information of a plurality of point of each patch. The texture image is used to represent color information of the plurality of points. Then, the patch expanding module 86 may perform operations similar to those of the patch expanding module 10 described above.

Taking the patch P1 as an example, since the patches P1 to P6 have been obtained, a point cloud composed of the patches P1 to P6 can be inferred from the patches P1 to P6. For at least one sampling point in the patch P1, the patch expanding module 86 may obtain at least one neighboring point less than a threshold (e.g., the first threshold described above) away from the sampling point in the point cloud composed of the patches P1 to P6, and adds the neighboring point to the patch P1. For example, the geometry image included by the patch P1 is used to represent the location information of the points of the patch P1 and the texture image of the patch P1 is used to represent the color information of the points of the patch P1. The patch expanding module 86 adds a location of the neighboring point to the geometry image of the patch P1 and adds a color of the neighboring point to the texture image of the patch P1.

It should be noted that in the example of adding neighboring points to the patch P1, in an embodiment, the patch expanding module 86 obtains the occupancy map corresponding to the patch P1. As similar to the previous description, the occupancy map includes at least one occupied block and at least one empty block. Here, the occupied block is used to represent a block having data in a 2D map (i.e., the 2D image) corresponding to the patch P1, and the empty block is used to represent a block not having data in the 2D map. When the neighboring point is added to the patch P1 and a number of the occupied blocks corresponding to the patch P1 is increased, the patch expanding module 86 does not add the neighboring point to the patch P1.

Further, in an embodiment, the patch expanding module 86 executes the operation of obtaining the neighboring point in the point cloud less than the first threshold away from the sampling point only when a number of points in the patch P1 is greater than a threshold (e.g., the second threshold described above).

In an embodiment, when a plurality of matching neighboring points (i.e., with their distances less than the first threshold) are found for one particular sampling point of the patch, the patch expanding module 10 simply adds a number (e.g., the first number described above) of the neighboring points to the patch P1, and the first number is less than a threshold (e.g., the third threshold described above). In other words, for one particular sampling point in the patch P1, only a certain number of the neighboring points are added the patch P1 so as to avoid adding too many neighboring points. The disclosure is not intended to limit how to select the neighboring point to be added to the patch from the found neighboring points.

Further, in an embodiment, the patch expanding module 86 scans the points in the point cloud PC to find the neighboring point less than the first threshold away from each point (or only the point of each boundary) in the patch P1, and adds the neighboring points to the patch P1 to obtain the patch as shown in the image 301.

It should be noted that, the neighboring point added to the patch P1 usually belongs to another patch of the same point cloud PC. Said another patch is another subset of the point cloud. By adding the point from a different patch to one patch, the problem of the crack occurred due to distortion at the intersections of the patches when the decoder is reconstructing may be solved.

Although the foregoing description is based on patch P1 as an example, similar processes may be applied to the patches P2 to P6, which are not repeated hereinafter.

After the patches P1 to P6 added with the neighboring points are obtained, in step S409, a point cloud reconstruction module (not illustrated) may be used to reconstruct the point cloud PC according to the patches P1 to P6 so as to obtain the reconstructed point cloud PC.

It should be noted that in the example of FIG. 4A, the patch expanding module 86 is coupled behind the color smoothing module 84, but the disclosure is not limited thereto. In other embodiments, the patch expanding module 86 may also be disposed and coupled behind the geometry image reconstruction module 78 or the texture image reconstruction module 82. Further, in this embodiment, the encoder 1000 and the decoder 4000 both include the patch expanding module. Nonetheless, in other embodiments, it is also possible that only one of the encoder 1000 and the decoder 4000 includes the patch expanding module.

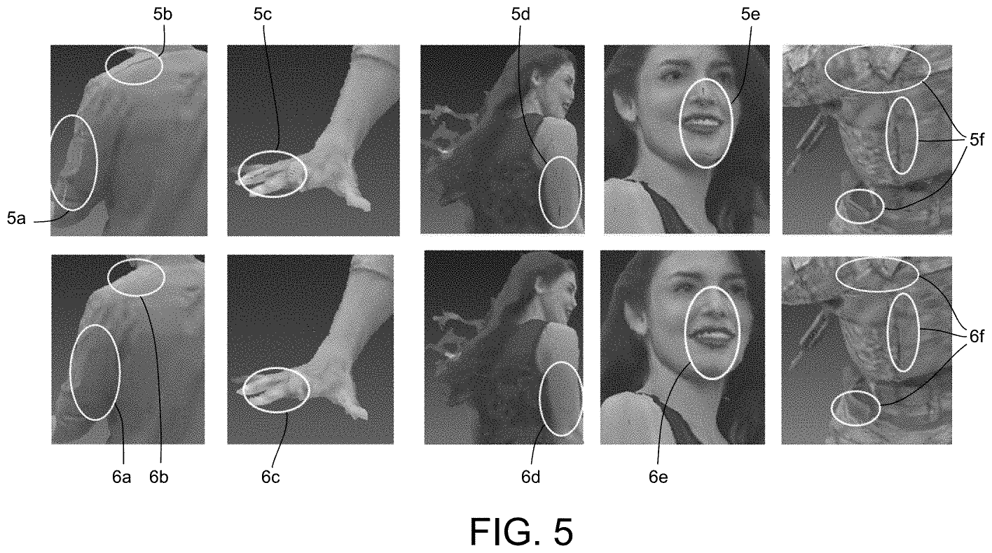

FIG. 5 is a schematic diagram illustrating the effect of a patch extension method according to an embodiment of the disclosure.

Referring to FIG. 5, in the point cloud reconstructed from the compressed patch using a conventional method, it can be seen that there are obvious cracks in areas 5a to 5f. However, by using the patch extension method of the disclosure, it can be seen that there are no obvious cracks in areas 6a to 6f (corresponding to the areas 5a to 5f). Therefore, the patch extension method of the disclosure can effectively solve the problem of the crack occurred due to distortion at the intersections of the patches, so as to improve data quality of the point cloud decoded by the decoder.

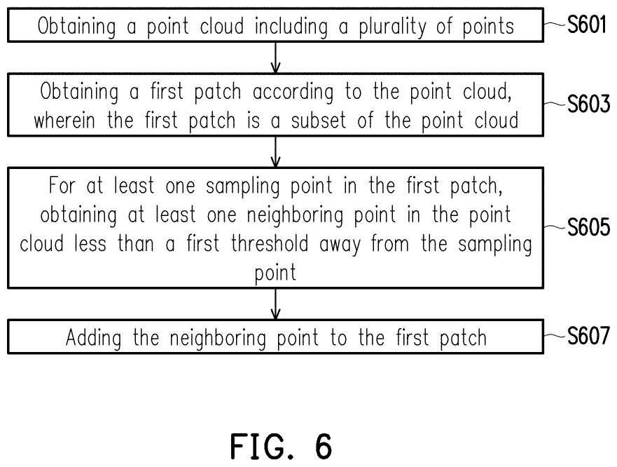

FIG. 6 is a flowchart illustrating a patch extension method according to an embodiment of the disclosure.

Referring to FIG. 6, first, a point cloud including a plurality of points is obtained (step S601). A first patch is obtained according to the point cloud (step S603). Here, the first patch is a subset of the point cloud. Then, for at least one sampling point in the first patch, at least one neighboring point in the point cloud less than a first threshold away from the sampling point is obtained (step S605). Lastly, the neighboring point is added to the first patch (step S607).

In summary, the patch extension method, the encoder and the decoder of the disclosure can effectively solve the problem of the crack occurred due to distortion at the intersections of the patches, so as to improve data quality of the point cloud decoded by the decoder.

1. A patch extension method, comprising:
obtaining a point cloud comprising a plurality of points;
obtaining a first patch according to the point cloud, wherein the first patch is a subset of the point cloud;
for at least one sampling point in the first patch, obtaining at least one neighboring point in the point cloud less than a first threshold away from the sampling point; and
adding the neighboring point to the first patch.

2. The patch extension method according to claim 1, wherein the step of obtaining the first patch according to the point cloud comprises:
projecting the plurality of points of the point cloud onto a plurality of 2D planes; and
obtaining the first patch according to a plurality of first points clustered on a first 2D plane among the plurality of 2D planes,
wherein the first patch comprises a geometry image and a texture image, the geometry image is used to represent location information of the plurality of first points and the texture image is used to represent color information of the plurality of first points.

3. The patch extension method according to claim 2, wherein the step of adding the neighboring point to the first patch comprises:
adding a location of the neighboring point to the geometry image and adding a color of the neighboring point to the texture image.

4. The patch extension method according to claim 3, further comprising:
generating an integrated geometry image according to the geometry image added with the location of the neighboring point and another geometry image of another patch belonging to the first 2D plane;
generating an integrated texture image according to the texture image added with the color of the neighboring point and another texture image of said another patch belonging to the first 2D plane;
compressing the integrated geometry image to obtain first compressed data;
compressing the integrated texture image to obtain second compressed data; and
outputting the first compressed data and the second compressed data.

5. The patch extension method according to claim 1, further comprising:
obtaining a first occupancy map corresponding to the first patch, wherein the first occupancy map comprises at least one occupied block and at least one empty block, the occupied block is used to represent a block having data in a 2D map corresponding to the first patch, and the empty block is used to represent a block not having data in the 2D map;
when the neighboring point is added to the first patch and a number of the occupied blocks in the first occupancy map is increased, not adding the neighboring point to the first patch.

6. The patch extension method according to claim 1, further comprising:
executing the step of obtaining the neighboring point in the point cloud less than the first threshold away from the sampling point only when a number of points in the first patch is greater than a second threshold.

7. The patch extension method according to claim 1, further comprising:
adding a first number of the neighboring points to the first patch, wherein the first number is less than a third threshold.

8. The patch extension method according to claim 1, wherein the sampling point is a point located on a boundary of the first patch.

9. The patch extension method according to claim 1, wherein the neighboring point belongs to a second patch, and the second patch is another subset of the point cloud.

10. An encoder, comprising:
a patch generation module, configured to obtain a point cloud comprising a plurality of points, and obtain a first patch according to the point cloud, wherein the first patch is a subset of the point cloud;
a patch expanding module, configured to, for at least one sampling point in the first patch, obtain at least one neighboring point in the point cloud less than a first threshold away from the sampling point, and add the neighboring point to the first patch;
a compression module, configured to compress the first patch added with the neighboring point to obtain compressed data; and
an output module, configured to output the compressed data.

11. The encoder according to claim 10, wherein in the operation of obtaining the first patch according to the point cloud,
the patch generation module projects the plurality of points of the point cloud onto a plurality of 2D planes, and obtains the first patch according to a plurality of first points clustered on a first 2D plane among the plurality of 2D planes,
wherein the first patch comprises a geometry image and a texture image, the geometry image is used to represent location information of the plurality of first points and the texture image is used to represent color information of the plurality of first points.

12. The encoder according to claim 11, wherein in the operation of adding the neighboring point to the first patch,
the patch expanding module adds a location of the neighboring point to the geometry image and adds a color of the neighboring point to the texture image.

13. The encoder according to claim 12, further comprising:
a patch packing module, configured to integrate the geometry image added with the location of the neighboring point and another geometry image of another patch belonging to the first 2D plane, and integrate the texture image added with the color of the neighboring point and another texture image of said another patch belonging to the first 2D plane;
an image generation module, configured to generate an integrated geometry image integrated from the geometry image added with the location of the neighboring point and said another geometry image of said another patch belonging to the first 2D plane, and generate an integrated texture image integrated from the texture image added with the color of the neighboring point and said another texture image of said another patch belonging to the first 2D plane, wherein
the compression module is further configured to compress the integrated geometry image to obtain first compressed data and compress the integrated texture image to obtain second compressed data, and
the output module is further configured to output the first compressed data and the second compressed data.

14. The encoder according to claim 10, wherein
the patch expanding module executes the operation of obtaining the neighboring point in the point cloud less than the first threshold away from the sampling point only when a number of points in the first patch is greater than a second threshold.

15. The encoder according to claim 10, wherein
the patch expanding module is further configured to add a first number of the neighboring points to the first patch, wherein the first number is less than a third threshold.

16. The encoder according to claim 10, wherein the sampling point is a point located on a boundary of the first patch.

17. The encoder according to claim 10, wherein the neighboring point belongs to a second patch, and the second patch is another subset of the point cloud.

18. A decoder, comprising:
a decompression module, configured to decompress at least one compressed data corresponding to a point cloud comprising a plurality of points to obtain at least one decompressed data, wherein the decompressed data comprises a first patch and the first patch is a subset of the point cloud;
a patch expanding module, configured to, for at least one sampling point in the first patch, obtain at least one neighboring point in the point cloud less than a first threshold away from the sampling point, and add the neighboring point to the first patch; and
a point cloud reconstruction module, configured to reconstruct the point cloud according to the first patch added with the neighboring point to obtain the reconstructed point cloud.

19. The decoder according to claim 18, wherein the first patch comprises a geometry image and a texture image, the geometry image is used to represent location information of a plurality of first points of the first patch, the texture image is used to represent color information of the plurality of first points, and
the patch expanding module adds a location of the neighboring point to the geometry image and adds a color of the neighboring point to the texture image.

20. The decoder according to claim 18, wherein
the patch expanding module executes the operation of obtaining the neighboring point in the point cloud less than the first threshold away from the sampling point only when a number of points in the first patch is greater than a second threshold.

21. The decoder according to claim 18, wherein
the patch expanding module is further configured to add a first number of the neighboring points to the first patch, wherein the first number is less than a third threshold.

22. The decoder according to claim 18, wherein the sampling point is a point located on a boundary of the first patch.

23. The decoder according to claim 18, wherein the neighboring point belongs to a second patch, and the second patch is another subset of the point cloud.
